(19) United States
(12) Patent Application Publication
(10) Pub. No.: US 2019/0031155 A1
(43) Pub. Date: Jan. 31, 2019

(54) CLEANING SYSTEM

(71) Applicant: AISIN SEIKI KABUSHIKI KAISHA, Kariya-shi (JP)

(72) Inventors: Taichi MIZUNO, Anjo-shi (JP); Hidetoshi INAYOSHI, Nukata-gun (JP)

(73) Assignee: AISIN SEIKI KABUSHIKI KAISHA, Kariya-shi (JP)

(21) Appl. No.: 16/025,337

(22) Filed: Jul. 2, 2018

(30) Foreign Application Priority Data
Jul. 25, 2017 (JP) 2017-143979

(51) Int. Cl. B60S 1/56; F04B 45/04; B60S 1/54; B60S 1/50; F04B 35/01; B60K 25/10; B08B 5/02; B08B 3/08

(52) U.S. Cl. CPC B60S 1/56; F04B 45/04; B60S 1/54; B60S 1/50; F15B 1/02; B60K 25/10; B08B 5/02; B08B 3/08; F04B 35/01

(57) ABSTRACT

A cleaning system includes: a pump portion that includes an air chamber that is capable of drawing in air from an outside, and an oscillating body which oscillates due to vibration of a vehicle and changes a volume of the air chamber so as to discharge the air drawn in the air chamber from the air chamber; and a nozzle that is disposed to face an information collecting surface of an information acquiring portion provided in the vehicle and injects the air discharged from the air chamber onto the information collecting surface.

### CROSS REFERENCE TO RELATED APPLICATIONS

This application is based on and claims priority under 35 U.S.C. § 119 to Japanese Patent Application 2017-143979, filed on Jul. 25, 2017, the entire contents of which are incorporated herein by reference.

### TECHNICAL FIELD

This disclosure relates to a cleaning system.

### BACKGROUND DISCUSSION

In the related art, there is a vehicle including a cleaning apparatus that injects air to a lens of a camera that acquires imaging data to be used for monitoring a periphery of a vehicle or the like to clean the lens (for example, see JP 2014-201150A (Reference 1) and JP 2016-008005A (Reference 2)). In addition, in order to improve a cleaning effect, an apparatus for injecting a cleaning liquid together with air is also proposed (see WO 2014/010580 (Reference 3)).

However, the cleaning apparatus of Reference 1 is provided to suppress adhesion of dirt in advance by applying air to a lens surface during traveling, has a complicated structure, and there is room for improvement in cleaning power after adhesion of dirt. In the cleaning apparatus of References 2 and 3, an electric motor or the like for generating air to be injected onto the lens surface is required and there is also room for improvement in terms of energy efficiency.

Thus, a need exists for a cleaning system which is not susceptible to the drawback mentioned above.

### SUMMARY

A cleaning system according to an aspect of this disclosure includes a pump portion that includes an air chamber that is capable of drawing in air from an outside, and an oscillating body which oscillates due to vibration of a vehicle and changes a volume of the air chamber so as to discharge the air drawn in the air chamber from the air chamber; and a nozzle that is disposed to face an information collecting surface of an information acquiring portion provided in the vehicle and injects the air discharged from the air chamber onto the information collecting surface.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a transparent view of a vehicle with which a cleaning system according to an embodiment is equipped as viewed from above and is a view for explaining a schematic configuration of the cleaning system;

FIG. 2 is a view illustrating a schematic configuration view illustrating an example in which a pump portion of the cleaning system according to the embodiment is disposed in a suspension apparatus of the vehicle;

FIG. 3 is a sectional view illustrating details of the pump portion capable of being disposed in the suspension apparatus in the cleaning system according to the embodiment;

FIG. 4 is a configuration conceptual diagram illustrating a configuration example between the pump portion and a nozzle of the cleaning system according to the embodiment;

FIG. 5 is a configuration conceptual diagram illustrating another configuration example between the pump portion and the nozzle of the cleaning system according to the embodiment;

FIG. 6 is a configuration conceptual diagram illustrating a configuration capable of introducing a cleaning liquid into a pressure accumulation tank in another configuration example between the pump portion and the nozzle of the cleaning system according to the embodiment;

FIG. 7 is a sectional view schematically illustrating another configuration of the pump portion of the cleaning system according to the embodiment;

FIG. 8 is a sectional view schematically illustrating a modification example of the pump portion illustrated in FIG. 7;

FIG. 9 is a sectional view schematically illustrating a modification example of the pump portion illustrated in FIG. 8;

FIG. 10 is a sectional view schematically illustrating a modification example of the pump portion illustrated in FIG. 7 and a structure including two discharging ports; and

FIG. 11 is a sectional view schematically illustrating a modification example of the pump portion illustrated in FIG. 10 and a structure in which an air chamber is formed by a diaphragm.

### DETAILED DESCRIPTION

Hereinafter, exemplary embodiments of this disclosure will be described. Configuration of the embodiments illustrated below, operations, results, and effects brought about by the configurations are examples. This disclosure can be realized not only by the configuration disclosed in the following embodiments but also can obtain at least one of various effects based on a basic configuration and derivation effects.

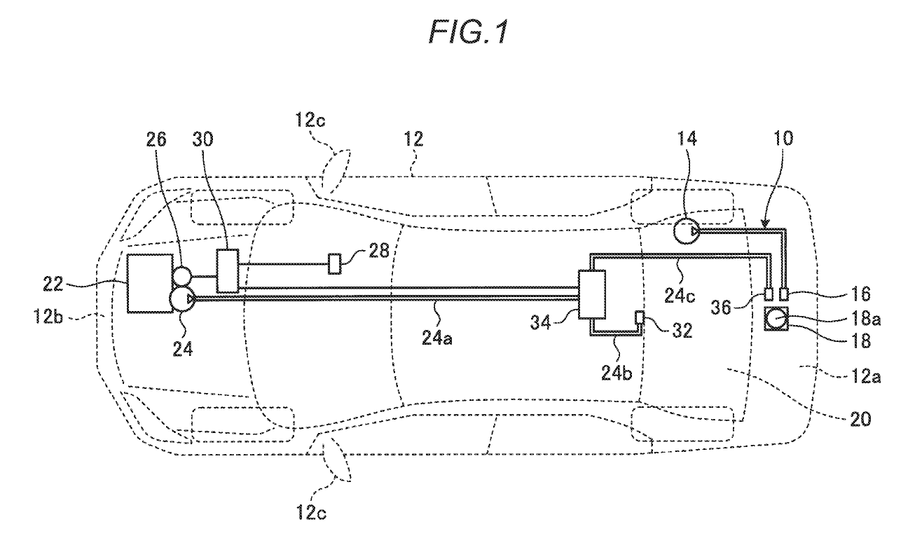

FIG. 1 is a transparent view of a vehicle 12 with which a cleaning system 10 according to an embodiment is equipped as viewed from above and is a view for explaining a schematic configuration of the cleaning system 10. The cleaning system 10 of the embodiment accelerates removal of dirt on an information collecting surface by discharging air using vibration of the vehicle 12 as a power source and injecting the air onto an information collecting surface of the information acquiring portion.

Moreover, in the embodiment, the information acquiring portion can be, for example, an imaging portion (for example, camera, infrared sensor, or the like) that acquires a situation of a periphery of the vehicle 12 as imaging data, a distance measuring sensor (ultrasonic sensor, laser sensor, or the like) for detecting an object (for example, obstacle) or measuring a distance to the object, and a mirror (rearview mirror, side mirror, or the like) for reflecting a reflected image. In addition, the information collecting surface is a lens in a case of the imaging portion and is a surface for transmitting and receiving ultrasonic waves or laser light in a case of the distance measuring sensor. In addition, the information collecting surface is a reflecting surface in a case of the mirror. Moreover, these are examples and, for example, can be applied to the information collecting surface of the information acquiring portion that may cause deterioration in detection accuracy or an undetected state due to adhesion of dust, mud, dry traces of moisture, or the like.

The cleaning system 10 mainly includes a pump portion 14 and a nozzle 16. The pump portion 14 includes an air chamber that is capable of drawing in air from an outside, and an oscillating body which oscillates due to vibration of the vehicle 12 and changes a volume of the air chamber so as to discharge the air drawn in the air chamber from the air chamber. Details of the pump portion 14 will be described later. The nozzle 16 is disposed to face the information collecting surface of the information acquiring portion provided in the vehicle 12 and injects the air discharge from the air chamber onto the information collecting surface. In a case of FIG. 1, the information acquiring portion is, for example, an imaging portion 18 (for example, digital camera, or the like) that acquires information (captured image data) mainly indicating a situation behind of the vehicle 12 and the information collecting surface is a lens 18a included in the imaging portion 18. Moreover, the cleaning system 10 may be applied to the imaging portion 18 disposed at a position other than a rear portion 12a of the vehicle illustrated in FIG. 1. In a case where a situation in front of the vehicle 12 is acquired, the imaging portion 18 is disposed, for example, in a front portion 12b of the vehicle and the cleaning system 10 is applied. In addition, in a case where a situation of a side of the vehicle 12 is mainly acquired, the imaging portion 18 is disposed in, for example, a side mirror 12c and the cleaning system 10 is applied.

In a case of the cleaning system 10 illustrated in FIG. 1, in addition to the pump portion 14 and the nozzle 16 which are basic configurations, a configuration is also added which allows a cleaning liquid used for cleaning a rear window 20 to be supplied to the lens 18a. A supply device for supplying the cleaning liquid to a front window of the vehicle 12 is provided as standard equipment in a general vehicle. In addition, there are also a number of vehicles provided with a supply device of a similar configuration that supplies the cleaning liquid to the rear window 20. The supply device of the cleaning liquid includes, for example, a washer tank 22 that is disposed in an engine compartment or the like, a washer pump 24 for pumping up and sending the cleaning liquid from the washer tank 22, and a motor 26 that drives the washer pump 24. When a driver operates an operation switch 28 disposed in a driver's seat of the vehicle 12, the motor 26 is driven via a control portion 30 and the cleaning liquid in the washer tank 22 is supplied from a rear nozzle 32 to the rear window 20 by an operation of the washer pump 24. In a case of the cleaning system 10, in order to supply the cleaning liquid stored in the washer tank 22 to the lens 18a, a switching portion 34 for branching a main flow path pipe 24a connected to the washer pump 24 is provided. The main flow path pipe 24a is connected to an upstream side of the switching portion 34, and a first branch pipe 24b connected to the rear nozzle 32 facing the rear window 20 and a second branch pipe 24c connected to a supply nozzle 36 facing the lens 18a are connected to a downstream side thereof. For example, the control portion 30 controls the switching portion 34 based on an operation state of the operation switch 28 to switch between a window cleaning mode in which the cleaning liquid is discharged from the rear nozzle 32 facing the rear window 20 and a sensor cleaning mode in which the cleaning liquid is discharged from the supply nozzle 36 facing the lens 18a.

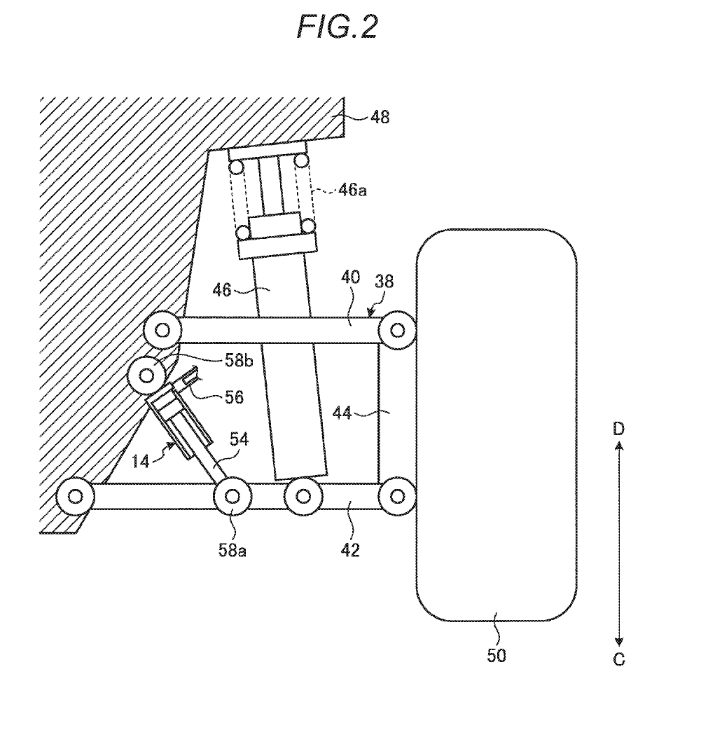

As described above, the pump portion 14 of the cleaning system 10 of the embodiment performs a pumping operation using vibration of the vehicle 12 as a driving source to perform discharging of air. In a case of FIG. 1, an example, in which the pump portion 14 is associated with a suspension apparatus that is one of the most vibrating components in the vehicle 12, is provided, and FIG. 2 is a schematic view in which a periphery of a suspension apparatus 38 is enlarged to explain details of an arrangement state of the pump portion 14.

FIG. 2 is a view schematically illustrating a suspension apparatus of a double wishbone type as an example of the suspension apparatus 38. The suspension apparatus 38 includes an upper arm 40 (arm portion), a lower arm 42 (arm portion), a hub carrier 44, a shock absorber 46, and the like. One end side of the upper arm 40 and one end side of the lower arm 42 are rotatably connected to a part of a body 48 (vehicle body) of the vehicle 12. In addition, the other side of the upper arm 40 and the other side of the lower arm 42 are rotatably connected to the hub carrier 44 supporting a hub on which a wheel 50 is mounted. In addition, one end side of the shock absorber 46 including a spring 46a is fixed to the body 48 and the other side thereof is rotatably connected to the lower arm 42. Therefore, the suspension apparatus 38 corresponds to the vibration in the upward and downward direction, the vibration thereof is promptly attenuated by the shock absorber 46 and the spring 46a, and is suppressed to be transmitted to the body 48. In the example of FIG. 2, one end side is rotatably connected to the body 48 and the other end side of the pump portion 14 is rotatably connected to the lower arm 42, and they are disposed so as to directly receive an influence of a movement (vibration) of the suspension apparatus 38 (lower arm 42) in the upward and downward direction. Moreover, in another embodiment, for example, one end may be rotatably connected to the body 48 and the other end of the pump portion 14 may be rotatably connected to the upper arm 40, and similarly, they may receive the influence of the vibration. In addition, since the upper arm 40 and the lower arm 42 move relatively to each other, the pump portion 14 may be disposed so as to bridge between the upper arm 40 and the lower arm 42.

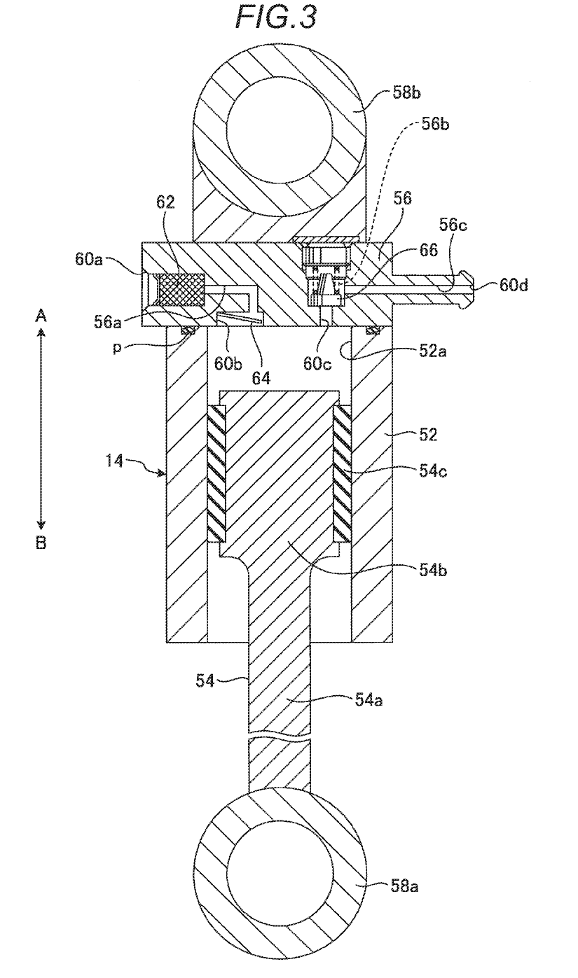

FIG. 3 is a sectional view illustrating a detail structure of the pump portion 14 capable of being disposed in the suspension apparatus 38 illustrated in FIG. 2. The pump portion 14 is configured of a cylinder 52 (housing), a piston 54 (oscillating body), a valve body 56, attaching portions 58a and 58b, and the like. The cylinder 52 is, for example, a cylindrical component, one end thereof is opened, and a sliding portion 54b is accommodated in an inside of the cylinder 52 to be capable of advancing and retreating (capable of oscillating) in directions of arrows A and B in a state where a rod portion 54a of the piston 54 is projected. The piston 54 which is the oscillating body is a rod-like component configured of the rod portion 54a and the sliding portion 54b, and a piston bushing 54c, which has good slidability and maintains airtightness of an air chamber 52a formed in the cylinder 52, is provided in a periphery of the sliding portion 54b. The piston bushing 54c can be configured of, for example, silicon resin, a rubber material, or the like. In addition, the attaching portion 58a for rotatably connecting to the lower arm 42 is fixed to a tip of the rod portion 54a.

The valve body 56 is fixed to the other end side of the cylinder 52 by a fastening member such as a screw in such a manner as to cover the air chamber 52a. Moreover, a seal member p is interposed in fixing surfaces and airtightness is maintained. The valve body 56 includes a first port 60a serving as a suction port, a second port 60b and a third port 60c communicating with the air chamber 52a, and a fourth port 60d serving as a discharging port. A filter 62 is provided on an inside of the first port 60a to remove foreign matters, moisture, and the like contained in air (outside air) drawn in from the first port 60a. For example, a plate-like inlet valve 64 (reed valve) is provided in the second port 60b and closes the valve to close a suction path 56a, that is, the second port 60b when the piston 54 moves to a side where the volume of the air chamber 52a decreases (when the piston 54 moves to a top dead center side in the direction of the arrow A). On the other hand, the inlet valve 64 (reed valve) opens the valve, opens the suction path 56a, that is, the second port 60b, and allows air from the first port 60a to draw in the air chamber 52a when the piston 54 moves to a side where the volume of the air chamber 52a increases (when the piston 54 moves to a bottom dead center side in the direction of the arrow B). The third port 60c is provided with, for example, a conical outlet valve 66 which is urged by a spring 56b toward a side (air chamber 52a side) on which the third port 60c is closed. In a case where an internal pressure of the air chamber 52a is equal to or less than a set pressure for moving the outlet valve 66 against an urging force of the spring 56b, the outlet valve 66 is closed and closes the third port 60c. On the other hand, in a case where the internal pressure of the air chamber 52a exceeds the set pressure of the outlet valve 66 (spring 56b), the outlet valve 66 moves in the direction of the arrow A to open the valve and opens the third port 60c. As a result, a compressed air which is drawn and compressed in the air chamber 52a is discharged (injected) from the fourth port 60d via a discharge path 56c.

As illustrated in FIG. 2, the piston 54 of the pump portion 14 is rotatably connected to the lower arm 42 via the attaching portion 58a and the cylinder 52 of the pump portion 14 on the valve body 56 side is rotatably connected to the body 48 via the attaching portion 58b. For example, when the vehicle 12 travels, the suspension apparatus 38 moves up and down according to a state of a road surface or the like. Specifically, when the wheel 50 is displaced in a direction (direction of an arrow C) away from the body 48, the lower arm 42 and the upper arm 40 rotate in the clockwise direction, the piston 54 moves in a projecting direction, and the air chamber 52a moves in an enlarged direction (see FIG. 3). In this case, since the air chamber 52a becomes a negative pressure, the inlet valve 64 opens and the outlet valve 66 closes. As a result, air (outside air) can be drawn (sucked) in the air chamber 52a from the first port 60a via the suction path 56a and the inlet valve 64. Subsequently, when the wheel 50 is displaced in a direction (direction of an arrow D) approaching the body 48, the lower arm 42 and the upper arm 40 rotate in the counterclockwise direction, the piston 54 moves in a storage direction, and the air chamber 52a moves in a reducing direction. In this case, since the air chamber 52a becomes a positive pressure, the inlet valve 64 closes and in a case where an internal pressure of the air chamber 52a exceeds a set pressure (set pressure set by the urging force of the spring 56b), the outlet valve 66 opens. As a result, the compressed air in the air chamber 52a is discharged (injected) from the fourth port 60d via the discharge path 56c.

As described above, the cylinder 52 (housing) configuring the pump portion 14 is rotatably connected to a part of the body 48 of the vehicle 12 and the piston 54 (oscillating body) is rotatably connected to a part of the lower arm 42, so that the up-and-down operation of the lower arm 42 according to the up-and-down movement of the wheel 50 directly and forcedly slides (oscillates) the piston 54. As a result, expansion and reduction of the volume of the air chamber 52a can be efficiently and repeatedly executed, and drawing-in and discharging of air in the air chamber 52a of the pump portion 14 can be executed more efficiently. That is, pumping of the pump portion 14 can be executed more efficiently.

The cleaning system 10 illustrated in FIG. 1 is one of the simplest configurations and is an example in which the pump portion 14 and the nozzle 16 are directly connected. When the vehicle 12 (suspension apparatus 38) vibrates due to traveling or the like, the piston 54 of the pump portion 14 reciprocates in the directions of the arrows A and B, so that the compressed air is injected from the nozzle 16 whenever the internal pressure of the air chamber 52a exceeds the set pressure to execute cleaning (removal of foreign matters and water droplets, blowing off) of the surface of the lens 18a. In addition, the cleaning effect of the surface of the lens 18a can be improved by supplying the cleaning liquid from the supply nozzle 36 prior to injection of the compressed air or during the injection. Moreover, it is possible to prevent the cleaning liquid from remaining in the lens 18a and to improve cleaning quality by repeatedly executing the injection of the compressed air from the nozzle 16 after the supply of the cleaning liquid from the supply nozzle 36. In addition, in a case of the configuration illustrated in FIG. 1, the compressed air is intermittently injected from the nozzle 16 while the suspension apparatus 38 vibrates, which can contribute to prevention of adhesion of dirt on the lens 18a.

As described above, according to the cleaning system 10, since the pump portion 14 using the vibration of the vehicle 12 as the driving source is used, it is possible to exhibit a sufficient effect for removing dirt after adhesion without consuming electric energy. In addition, it is possible to exhibit the effect of prevention of adhesion of dirt.

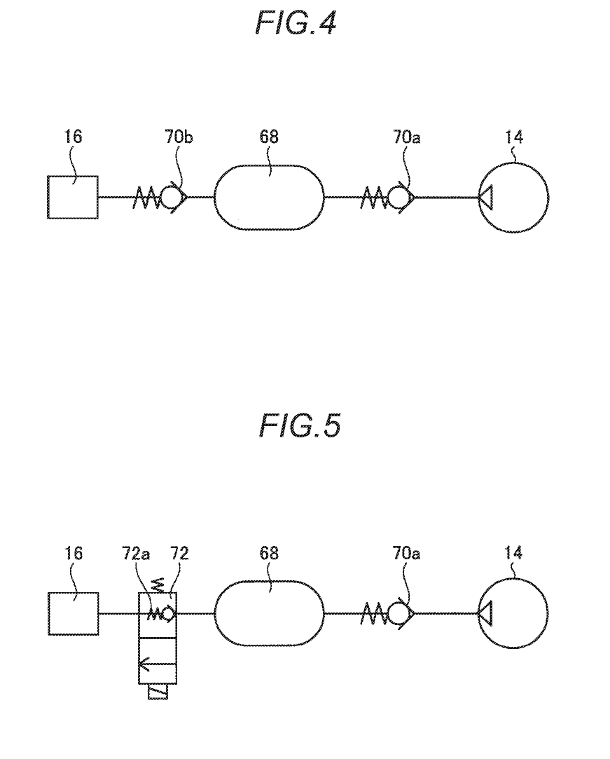

FIGS. 4 to 6 are schematic diagrams explaining configuration examples in which the cleaning ability is improved by interposing a pressure accumulation tank 68 between the pump portion 14 and the nozzle 16.

FIG. 4 is an example in which the pressure accumulation tank 68 is disposed between the pump portion 14 and the nozzle 16, a check valve 70a is disposed on an upstream side of the pressure accumulation tank 68, and a check valve 70b is disposed on a downstream side thereof. The pressure accumulation tank 68 preferably has strength and shape capable of storing (pressure-accumulating) a high-pressure compressed air, is formed at least in the cylinder 52 so as to perform cleaning (injection of the compressed air) for a plurality of times or for a long period, and has a volume larger than a maximum volume of the air chamber 52a. The check valve 70a prevents a reverse flow from the pressure accumulation tank 68 to the pump portion 14 and a set pressure of the check valve 70a is set to be able to open the valve by a discharge pressure of the pump portion 14. In addition, a set pressure of the check valve 70b is higher than the set pressure of the check valve 70a and is set to be able to open the valve at a pressure desired to be injected from the pressure accumulation tank 68, that is, a desired cleaning pressure. As illustrated in FIG. 4, it is possible to easily improve an injection pressure (cleaning power) of the air in the cleaning system 10 with a simple configuration in which the pressure accumulation tank 68 and the check valves 70a and 70b before and after the pressure accumulation tank 68 are added.

FIG. 5 is a modification example of FIG. 4 and a pressure accumulation tank 68 is disposed between a pump portion 14 and a nozzle 16, and a check valve 70a is provided on an upstream side of the pressure accumulation tank 68. On the other hand, a solenoid valve 72 is disposed on a downstream side of the pressure accumulation tank 68 instead of the check valve 70b. The solenoid valve 72 can be a normally closed solenoid valve (normally closed solenoid control valve) which has, for example, a solenoid and a spring which are ON/OFF controlled, and is in a valve closed state in a case where the solenoid is in a non-energized state. The solenoid valve 72 does not maintain the valve closed state at the time of non-energization in any case, and includes a check valve 72a allowing the injection of air from the nozzle 16 in a case where the pressure in the pressure accumulation tank 68 exceeds a limit pressure (pressure set in advance by a test or the like), so that an excessive increase in an internal pressure of the pressure accumulation tank 68 may be prevented.

As illustrated in FIG. 5, the solenoid valve 72 is disposed on the downstream side of the pressure accumulation tank 68, so that similar to the structure illustrated in FIG. 4, it is possible to improve the injection pressure (cleaning power) of the air in the cleaning system 10 and to control an injection timing by a valve opening operation of the solenoid valve 72. In addition, it is possible to further increase the pressure in the pressure accumulation tank 68 by delaying the timing of valve opening. In this case, the solenoid valve 72 can be open-and-close controlled by, for example, the control portion 30 and the open-and-close control can be executed by the operation switch 28 which is operated by the driver. Therefore, a cleaning timing desired by the driver, for example, a timing before traveling, a timing after traveling, or when a detection accuracy of the imaging portion 18 is lowered, when a detection error occurs, or the like, it is possible to execute cleaning using a strong air injection pressure-accumulated so far. In another embodiment, for example, in a case where lowering of the detection accuracy or detection error is recognized in an information processing portion or the like which performs processing based on detection information which is detected by the imaging portion 18, for example, the control portion 30 may open the solenoid valve 72 and perform automatic cleaning based on the result. Moreover, if a linear valve of which a valve opening degree can be adjusted is adopted as the solenoid valve 72, it is possible to switch the injection pressure and to improve the cleaning effect by increasing a cleaning pattern.

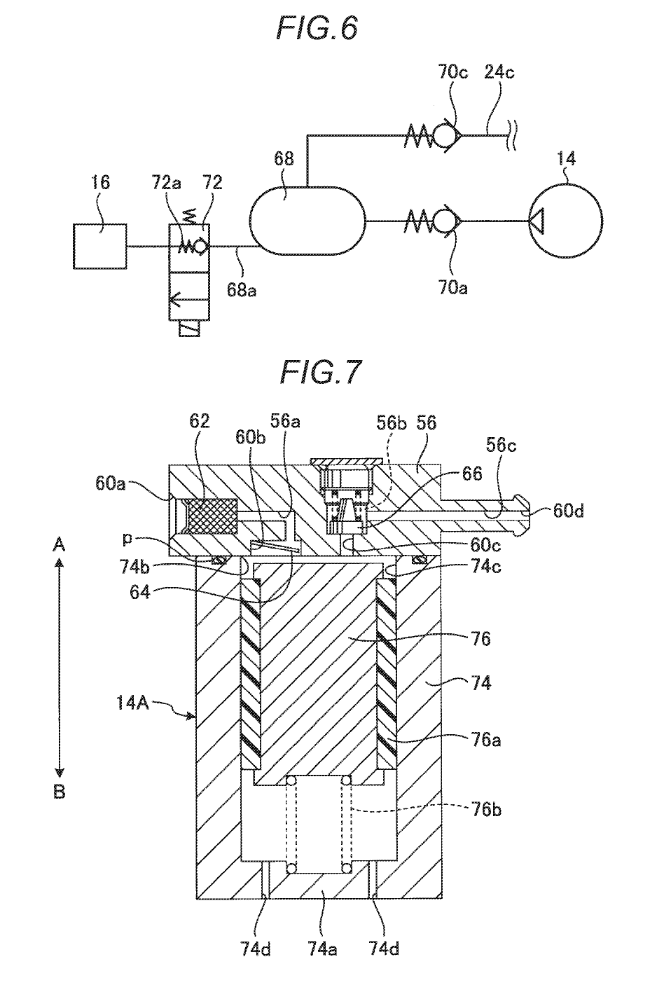

FIG. 6 is a modification example of FIG. 5, similar to the configuration of FIG. 5, and is an example in which a pressure accumulation tank 68 is disposed between a pump portion 14 and a nozzle 16, a solenoid valve 72 which has a check valve 70a on an upstream side of the pressure accumulation tank 68 and a check valve 72a on a downstream side thereof, is provided, and the cleaning liquid can be injected at a high pressure. For example, in FIG. 1, the second branch pipe 24c branched from the switching portion 34 is connected to the pressure accumulation tank 68 via a check valve 70c. The check valve 70c is configured so that the cleaning liquid does not flow back from the pressure accumulation tank 68 side to the second branch pipe 24c. In addition, the set pressure of the check valve 70c is set so as to open valve by a flow pressure of the cleaning liquid sent by the washer pump 24 and is configured so that the cleaning liquid is supplied to the pressure accumulation tank 68 by an operation of the washer pump 24. Moreover, in a case of the example illustrated in FIG. 6, an injection pipe 68a connected to the nozzle 16 is connected to the vicinity of a bottom surface of the pressure accumulation tank 68. Therefore, for example, if the cleaning liquid necessary for cleaning once is supplied to the pressure accumulation tank 68 from the washer tank 22 and an internal pressure of the pressure accumulation tank 68 is equal to or higher than the set pressure, when the solenoid valve 72 is opened, the cleaning liquid supplied to the pressure accumulation tank 68 can be efficiently injected from the nozzle 16 in a mist state (cleaning liquid mixture gas). For example, it is easy to inject a small amount of the cleaning liquid in a wide range so that an appropriate amount of injecting which does not cause excessive application can be easily realized. After all the cleaning liquid supplied to the pressure accumulation tank 68 is injected, if the solenoid valve 72 is kept opened, the injection is switched to only the compressed air. That is, a step of applying the cleaning liquid to the lens 18a at a high pressure as a first cleaning process and a step of blowing off the cleaning liquid used for cleaning and drying the surface of the lens 18a to bring the surface into a clean state as a second cleaning process can be realized with a simple configuration.

As described above, the cleaning liquid can be injected at a high pressure, so that the cleaning effect of the lens 18a can be further improved. In the case of the configuration illustrated in FIG. 6, similar to the case of the configuration illustrated in FIG. 5, cleaning may be executed at a desired timing by an operation of the operation switch 28 by the driver or in a case where dirt of the lens 18a is detected, cleaning may be automatically executed. In the case of the configuration illustrated in FIG. 6, as described above, it is possible to use a first cleaning mode in which cleaning is executed by using the cleaning liquid and a second cleaning mode in which cleaning is executed only by the compressed air without using the cleaning liquid.

An example, in which the pump portion 14 illustrated in FIG. 3 achieves the most effective pumping by combining with the suspension apparatus 38, is described. FIGS. 7 to 11 illustrate structures which are capable of being disposed at any position of the vehicle 12 and realize similar pumping as other pump structures. Moreover, in the structures of FIGS. 7 to 11, the same reference numerals are given to the same configurations as those in the pump portion 14 illustrated in FIG. 3 and detailed description thereof will be omitted.

A pump portion 14A illustrated in FIG. 7 is configured of a cylinder 74, a piston 76 (oscillating body), a valve body 56, and the like. The cylinder 74 is, for example, a cylindrical component, a bottom wall portion 74a is provided on one end side, and an opening portion 74b is provided on the other end side. The opening portion 74b is covered with the valve body 56 and an air chamber 74c is formed between the opening portion 74b and one end surface of the cylindrical piston 76 which is accommodated, for example, in the cylinder 74. The valve body 56 and the cylinder 74 are fixed by a fastening member such as a screw, and a seal member p is interposed in a joining portion to maintain airtightness. The piston 76 as the oscillating body reciprocates (oscillates) in directions of arrows A and B in an inner cylinder of the cylinder 74, so that a volume of the air chamber 74c is changed and a pumping operation for repeating a suction operation by which air (outside air) is drawn in the air chamber 74c and a discharging operation by which the drawn-in air is discharged is realized. The bottom wall portion 74a of the cylinder 74 is provided with air holes 74d so as not to have sliding resistance when the piston 76 reciprocates in the directions of the arrows A and B, that is, the volume of the air chamber 74c is reduced and enlarged. In the case of FIG. 7, two air holes 74d are illustrated, but as long as the reciprocating operation of the piston 76 can be smoothly performed, the number of formed holes or a diameter thereof can be appropriately changed.

A piston bushing 76a, which has good slidability and maintains airtightness of the air chamber 74c formed in the cylinder 74, is provided in a periphery of the piston 76. In addition, a spring 76b for urging the piston 76 in a direction (direction of the arrow A, the top dead center side) in which the volume of the air chamber 74c is reduced is disposed between a lower surface (surface opposite to an upper surface on which a part of the air chamber 74c is formed) of the piston 76 and the bottom wall portion 74a. A set pressure of the spring 76b is set so that the piston 76 floats due to its own weight when the vehicle 12 is not vibrated. The set pressure is set so that, for example, in a case where the piston 76 maintains a state of being stopped at the top dead center and the vehicle 12 is vibrated, the piston 76 is set to be capable of reciprocating in the cylinder 74 in the directions of the arrows A and B according to the vibration.

The valve body 56, which is fixed to the other end side (opening portion 74b side) of the cylinder 74 in such a manner as to cover the air chamber 74c, includes a first port 60a serving as the suction port, a second port 60b and a third port 60c communicating with the air chamber 74c, and a fourth port 60d serving as a discharging port. Similar to the structure of FIG. 3, a filter 62 is provided on an inside of the first port 60a. In addition, for example, a plate-like inlet valve 64 (reed valve) is provided in the second port 60b. The third port 60c is provided with, for example, a conical outlet valve 66 which is urged by a spring 56b toward a side on which the third port 60c is closed.

As described above, the pump portion 14A may be disposed at any position of the vehicle 12 as long as the position is easily affected by the vibration of the vehicle 12. For example, it may be in a rear trunk or may be in an engine compartment. In a case where the pump portion 14A is disposed such that the direction along the arrows A and B is a vertical direction (vehicle height direction) of the vehicle 12, the pump portion 14A can perform pumping in response to the vertical vibration of the vehicle 12. For example, when the piston 76 moves in the direction of the arrow B due to the vertical vibration of the vehicle 12 and the air chamber 74c moves in the enlarged direction, the air chamber 74c becomes a negative pressure, the inlet valve 64 opens, and the outlet valve 66 closes. As a result, air (outside air) is drawn (sucked) in from the first port 60a to the air chamber 74c via the suction path 56a and the inlet valve 64. Subsequently, when the piston 76 moves in the direction of the arrow A, the air chamber 74c moves in the reducing direction. In this case, the air chamber 74c becomes a positive pressure, the inlet valve 64 opens, and in a case where the internal pressure of the air chamber 74c exceeds the set pressure (set pressure of the spring 56b), the outlet valve 66 opens. As a result, the compressed air in the air chamber 74c is discharged (injected) from the fourth port 60d via the discharge path 56c.

As described above, the pump portion 14A can perform the pumping operation even if the pump portion 14A is disposed at any position of the vehicle 12 as long as the position is easily affected by the vertical vibration. As a result, a degree of freedom of installation layout in a case of being equipped with the cleaning system 10 is improved. In addition, in the case of the pump portion 14 illustrated in FIG. 3, the pump portion 14 is likely to be exposed to rainwater, mud, dust, or the like because the pump portion 14 is disposed in association with the suspension apparatus 38. On the other hand, in the case of the pump portion 14A illustrated in FIG. 7, it is possible to contribute to improvement of maintainability of the pump portion 14A because the pump portion 14 can be disposed in, for example, a place hard to be exposed to rainwater, mud, dust, or the like such as a trunk room. If the pump portion 14A is disposed such that the direction along the arrows A and B is a front-rear direction of the vehicle 12, the pump portion 14A can perform similar pumping using the acceleration and deceleration of the vehicle 12 and the same effect can be obtained.

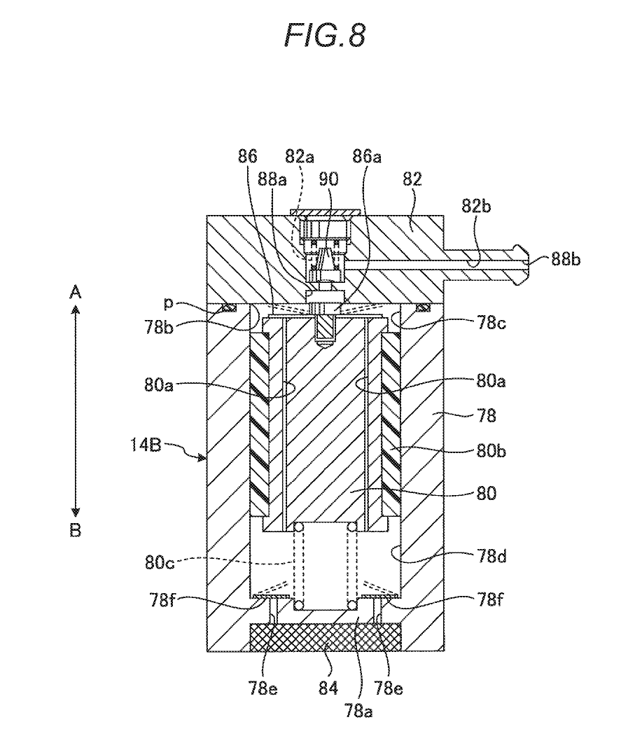

A pump portion 14B illustrated in FIG. 8 is a modification example of the pump portion 14A illustrated in FIG. 7 and is a structure example in which a suction port is provided in a bottom wall portion 78a at a position facing a valve body 82 with a cylinder 78 interposed therebetween.

The pump portion 14B illustrated in FIG. 8 is configured of the cylinder 78, a piston 80 (oscillating body), a valve body 82, and the like. The cylinder 78 is, for example, a cylindrical component, a bottom wall portion 78a is provided on one end side, and an opening portion 78b is provided on the other end side. The opening portion 78b is covered with the valve body 82 and a first air chamber 78c is formed between the opening portion 78b and one end surface (surface close to the valve body 82) of the piston 80 as the cylindrical oscillating body accommodated in the cylinder 78. The valve body 82 and the cylinder 78 are fixed by a fastening member such as a screw, and a seal member p is interposed in a joining portion to maintain airtightness. On the other hand, a second air chamber 78d is formed between the bottom wall portion 78a and the other end surface (surface away from the valve body 82) of the piston 80. The bottom wall portion 78a is provided with a suction port 78e for drawing air (outside air) in the second air chamber 78d and a filter 84, which removes foreign matters and moisture contained in air drawn in by the suction port 78e, outside the suction port 78e. In the example of FIG. 8, two suction ports 78e are illustrated, but it is preferable that the number of the suction ports 78e and a port diameter thereof are appropriately set, so that air is smoothly drawn in the second air chamber 78d. In addition, the cylinder 78 is provided with, for example, a plate-like check valve 78f (reed valve) so as to cover the suction port 78e communicating with the second air chamber 78d. In a case where the piston 80 moves in the direction of the arrow A and the second air chamber 78d becomes a negative pressure, the check valve 78f bends as indicated by a broken line and opens the valve, so that air (outside air) is drawn in the second air chamber 78d via the suction port 78e and the filter 84. On the other hand, in a case where the piston 80 moves in the direction of the arrow B and the second air chamber 78d becomes a positive pressure, the check valve 78f takes a flat posture as indicated by a solid line and the valve is closed, so that the air is suppressed to be leaked from the suction port 78e.

Through paths 80a are formed in the piston 80 to communicate one end surface on the first air chamber 78c side with the other end surface on the second air chamber 78d side. In the case of the example of FIG. 8, two through paths 80a are illustrated, but it is preferable that the number of the through paths 80a and a port diameter thereof are appropriately set, so that air drawn in the second air chamber 78d is smoothly moved to the first air chamber 78c side with the movement of the piston 80 in the direction of the arrow B. In addition, a plate-like inlet valve 86 (reed valve), which performs a valve closing operation so as to close the through paths 80a, is provided on one end surface of the piston 80 on the first air chamber 78c side. The inlet valve 86 is fixed to the piston 80 by, for example, a fastening member such as a bolt 86a. In a case where the piston 80 moves in the direction of the arrow A, that is, in a case where the piston 80 moves to reduce the volume of the first air chamber 78c to become a positive pressure, the inlet valve 86 takes a flat posture as indicated by a solid line and closes the through paths 80a. That is, communication between the first air chamber 78c and the second air chamber 78d is blocked. On the other hand, in a case where the piston 80 moves in the direction of the arrow B, that is, in a case where the piston 80 moves to reduce the volume of the second air chamber 78d to become a positive pressure, the inlet valve 86 bends as indicated by a broken line and allows communication between the first air chamber 78c and the second air chamber 78d.

A piston bushing 80b, which has good slidability and maintains airtightness of the first air chamber 78c and the second air chamber 78d formed in the cylinder 78, is provided in a periphery of the piston 80. In addition, a spring 80c for urging the piston 80 in a direction (direction of the arrow A, the top dead center side) in which the volume of the first air chamber 78c is reduced is disposed between a lower surface (surface facing the second air chamber 78d) of the piston 80 and the bottom wall portion 78a. A set pressure of the spring 80c is set so that the piston 80 floats due to its own weight when the vehicle 12 is not vibrated. The set pressure is set so that, for example, in a case where the piston 80 maintains a state of being stopped at the top dead center and the vehicle 12 is vibrated, the piston 80 is set to be capable of reciprocating in the cylinder 78 in the directions of the arrows A and B according to the vibration.

The valve body 82, which is fixed to the other end side (opening portion 78b side) of the cylinder 78 in such a manner as to cover the first air chamber 78c, includes a first port 88a communicating with the first air chamber 78c and a second port 88b serving as a discharging port. The first port 88a is provided with, for example, a conical outlet valve 90 which is urged by a spring 82a toward a side on which the first port 88a is closed.

Also, the pump portion 14B may be disposed at any position of the vehicle 12 as long as the position is easily affected by the vibration of the vehicle 12. For example, it may be in a rear trunk or may be in an engine compartment. In a case where the pump portion 14B is disposed such that the direction along the arrows A and B is a vertical direction (vehicle height direction) of the vehicle 12, the pump portion 14B can perform pumping in response to the vertical vibration of the vehicle 12. For example, when the piston 80 moves in the direction of the arrow B due to the vertical vibration of the vehicle 12 and the second air chamber 78d moves in a direction in which the second air chamber 78d is reduced, the second air chamber 78d becomes a positive pressure, the check valve 78f closes, and the inlet valve 86 opens, so that the air in the second air chamber 78d is drawn in the first air chamber 78c. On the other hand, when the piston 80, which moves in the direction of the arrow B, moves in the direction of the arrow A due to an urging force (repulsive force) of the spring 80c or the vibration of the vehicle 12 and moves in the direction in which the first air chamber 78c is reduced, the first air chamber 78c becomes a positive pressure, the inlet valve 86 closes, and in a case where an internal pressure of the first air chamber 78c exceeds a set pressure (set pressure of the spring 82a), the outlet valve 90 opens. As a result, the compressed air in the first air chamber 78c is discharged (injected) from the second port 88b via a discharge path 82b. In this case, the piston 80 moves in the direction of the arrow A and the second air chamber 78d becomes a negative pressure, so that the check valve 78f opens and air (outside air) is drawn in the second air chamber 78d via the suction port 78e and the filter 84. In this case, when the piston 80 next moves in the direction of the arrow B, the drawn-in air is sent to the first air chamber 78c side and a continuous pumping operation is realized.

As described above, also the pump portion 14B may perform the pumping operation even if the pump portion 14B is disposed at any position of the vehicle 12 as long as the position is easily affected by the vertical vibration. As a result, a degree of freedom of installation layout in a case of being equipped with the cleaning system 10 is improved. In addition, similar to the pump portion 14A illustrated in FIG. 7, for example, the pump portion 14B is capable of being disposed in a trunk room, an engine compartment, or the like, and it is possible to contribute to improvement of maintainability of the pump portion 14B because the pump portion 14B can be disposed in, for example, a place hard to be exposed to rainwater, mud, dust, or the like. Since the position of the suction port of the air is different between the pump portion 14A illustrated in FIG. 7 and the pump portion 14B illustrated in FIG. 8, when the cleaning system 10 is disposed in the vehicle 12, it is possible to consider the ease of drawing-in of air (outside air), to determine whether to adopt the pump portion 14A or the pump portion 14B, and to contribute to the improvement in the degree of freedom of installation.

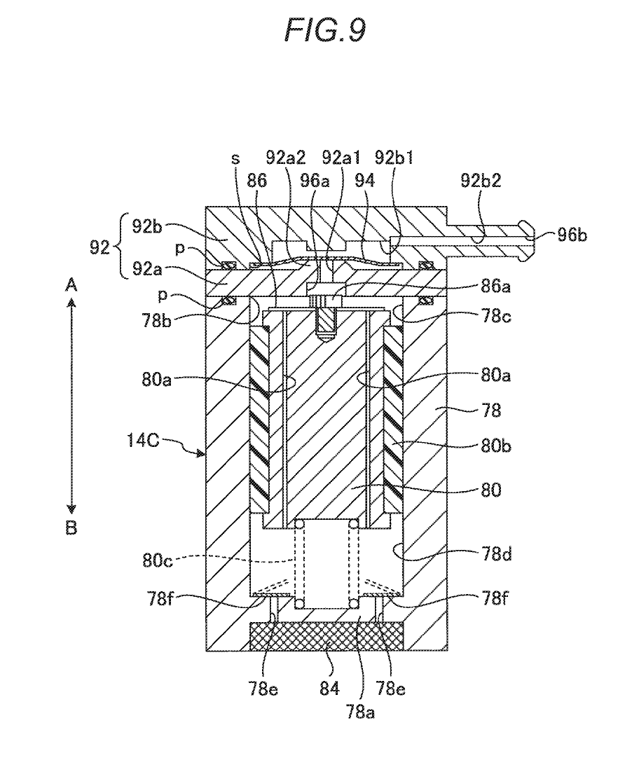

A pump portion 14C illustrated in FIG. 9 is a modification example of the pump portion 14B illustrated in FIG. 8 and the configuration of the cylinder 78 and the piston 80 is the same as that thereof except only that a valve body 92 has a two-part structure and a form of an outlet valve 94 is different. Therefore, the same reference numerals are given to the cylinder 78 and the piston 80, and detailed description thereof will be omitted.

The valve body 92 is configured of a first member 92a configuring a part of a first air chamber 78c which covers an opening portion 78b of the cylinder 78 and a second member 92b that covers a surface opposite to the opening portion 78b in the first member 92a. A through hole 92a1 communicating with the first air chamber 78c is formed in the first member 92a and a first air chamber 78c side of the through hole 92a1 is a first port 96a. A projection portion 92a2 is formed around the through hole 92a1 on a side opposite to the first port 96a in the first member 92a. A flat plate-like outlet valve 94 (reed valve) having flexibility is disposed to cover the through hole 92a1. The first member 92a and the cylinder 78 are fixed by a fastening member such as a screw and a seal member p is interposed in a joining portion to maintain airtightness. On the other hand, the second member 92b includes a recessed portion 92b1 which faces the through hole 92a1 and includes a step s capable of accommodating the outlet valve 94, and a discharge path 92b2 communicating with the recessed portion 92b1. A tip portion of the discharge path 92b2 is a second port 96b. As illustrated in FIG. 9, the step s of the second member 92b pushes the outlet valve 94 of a state (closed state) of covering the through hole 92a1 (projection portion 92a2) in the direction of the arrow B, so that the flat plate-like outlet valve 94 is bent by the projection portion 92a2. As a result, the outlet valve 94 functions as a check valve for closing the through hole 92a1 with a predetermined set pressure. Moreover, the first member 92a and the second member 92b are fixed by a fastening member such as a screw and a seal member p is interposed in a joining portion to maintain airtightness.

Also the pump portion 14C may be disposed at any position of the vehicle 12 as long as the position is easily affected by the vibration of the vehicle 12. For example, it may be in a rear trunk or may be in an engine compartment. In a case where the pump portion 14C is disposed such that the direction along the arrows A and B is a vertical direction (vehicle height direction) of the vehicle 12, the pump portion 14C can perform the pumping operation in response to the vertical vibration of the vehicle 12. For example, when the piston 80 moves in the direction of the arrow B due to the vertical vibration of the vehicle 12 and the second air chamber 78d moves in a direction in which the second air chamber 78d is reduced, the second air chamber 78d becomes a positive pressure, the check valve 78f closes, and the inlet valve 86 which is fixed to the piston 80 by a bolt 86a opens, so that the air in the second air chamber 78d is drawn in the first air chamber 78c. On the other hand, when the piston 80, which moves in the direction of the arrow B, moves in the direction of the arrow A due to an urging force (repulsive force) of the spring 80c or the vibration of the vehicle 12 and moves in the direction in which the first air chamber 78c is reduced, the first air chamber 78c becomes a positive pressure and the inlet valve 86 closes. Then, in a case where an internal pressure of the first air chamber 78c exceeds a set pressure (set pressure generated as a result of pushing the outlet valve 94 against the projection portion 92a2 by the second member 92b), the outlet valve 94 of which an outer peripheral portion is slidably supported by the step s is bent in the direction of the arrow A to open the valve. As a result, the compressed air in the first air chamber 78c is discharged (injected) from the second port 96b via a discharge path 92b2. In this case, the piston 80 moves in the direction of the arrow A and the second air chamber 78d becomes a negative pressure, so that the check valve 78f opens and air (outside air) is drawn in the second air chamber 78d via the suction port 78e and the filter 84. In this case, when the piston 80 next moves in the direction of the arrow B, the drawn-in air is sent to the first air chamber 78c side and a continuous pumping operation is realized.

As described above, also the pump portion 14C may perform the pumping operation even if the pump portion 14C is disposed at any position of the vehicle 12 as long as the position is easily affected by the vertical vibration. As a result, the degree of freedom of installation layout in a case of being equipped with the cleaning system 10 is improved. In addition, similar to the pump portions 14A and 14B, for example, the pump portion 14C is capable of being disposed in a trunk room, an engine compartment, or the like, and is hardly exposed to rainwater, mud, dust, or the like, and it is possible to contribute to improvement of maintainability of the pump portion 14C. In addition, the plate-like outlet valve 94 of the pump portion 14C is simpler in structure than the conical outlet valve 90 which is urged by the spring 82a of the pump portion 14B, which contributes to cost reduction. In addition, since the structure is simple, it can also contribute to improvement of maintainability.

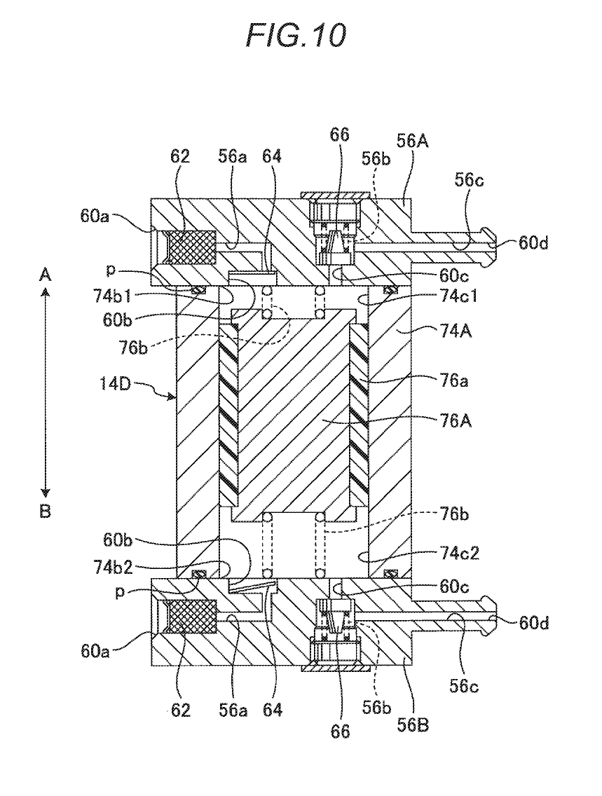

A pump portion 14D illustrated in FIG. 10 is a modification example of the pump portion 14A illustrated in FIG. 7 and is an example in which two valve bodies 56A and 56B are provided with a cylinder 74A interposed therebetween. The basic structure other than the provision of valve bodies 56A and 56B is the same as the pump portion 14A, and the same reference numerals are given to the same configurations and detailed description will be omitted.

The pump portion 14D illustrated in FIG. 10 is configured of the cylinder 74A, a piston 76A (oscillating body), the valve bodies 56A and 56B, and the like. The cylinder 74A is, for example, a cylindrical component and includes opening portions 74b1 and 74b2 at both ends. The opening portion 74b1 is covered with the valve body 56A, the opening portion 74b2 is covered with the valve body 56B, the opening portions 74b1 and 74b2 form a sliding space in which the piston 76A as the oscillating body is accommodated, and form a first air chamber 74c1 on a valve body 56A side and a second air chamber 74c2 on a valve body 56B side, respectively. The valve body 56A and the cylinder 74A, and the valve body 56B and the cylinder 74A are fixed by a fastening member such as a screw and a seal member p is interposed in a joining portion to maintain airtightness. The piston 76A reciprocates in directions of arrows A and B in an inner cylinder of the cylinder 74A due to the vibration of the vehicle 12 or the like, so that the pump portion 14D changes volumes of the first air chamber 74c1 and the second air chamber 74c2.

A piston bushing 76a, which has good slidability and maintains airtightness of the first air chamber 74c1 and the second air chamber 74c2 formed in the cylinder 74A, is provided in a periphery of the piston 76A. A spring 76b is disposed between the piston 76A and the valve body 56A in the first air chamber 74c1. Similarly, a spring 76b is disposed between the piston 76A and the valve body 56B in the second air chamber 74c2. In the case of FIG. 10, a state where the piston 76A as an example of an operating state moves to the valve body 56A side is illustrated. A set pressure of each spring 76b is set so that the piston 76A floats due to its own weight in a state where vibration is not applied to the pump portion 14D. The set pressures of the springs 76b are set so that, for example, the piston 76A stops (urges) at a neutral position (position where the first air chamber 74c1 and the second air chamber 74c2 have almost the same capacity) of the cylinder 74A. In a case where vibration is applied to the pump portion 14D, the piston 76A can smoothly reciprocate in the directions of the arrows A and B.

Structures of the valve body 56A and the valve body 56B are the same as that of the valve body 56 illustrated in FIG. 7, and each thereof includes a first port 60a serving as the suction port, a second port 60b and a third port 60c communicating with the first air chamber 74c1 or the second air chamber 74c2, and a fourth port 60d serving as a discharging port. A filter 62 is provided on an inside of the first port 60a. In addition, for example, a plate-like inlet valve 64 (reed valve) is provided in the second port 60b. The third port 60c is provided with, for example, a conical outlet valve 66 which is urged by a spring 56b toward a side on which the third port 60c is closed.

The pump portion 14D having such a configuration is disposed at a position which is easily affected by the vibration of the vehicle 12 like the pump portions 14A to 14C and executes the pumping operation due to the vibration of the vehicle 12. For example, when the piston 76A moves in the direction of the arrow A due to the vertical vibration of the vehicle 12 and the first air chamber 74c1 moves in a reducing direction, the first air chamber 74c1 becomes a positive pressure, the inlet valve 64 of the valve body 56A closes, and the outlet valve 66 of the valve body 56A opens at the time of exceeding the set pressure by the spring 56b. As a result, the compressed air drawn in the inside of the first air chamber 74c1 is discharged (injected) from the fourth port 60d via a discharge path 56c of the valve body 56A. On the other hand, when the piston 76A moves in the direction of the arrow A, the second air chamber 74c2 side moves in an enlarged direction, and the second air chamber 74c2 becomes a negative pressure. As a result, the inlet valve 64 of the valve body 56B opens and the outlet valve 66 of the valve body 56B closes. Therefore, air (outside air) is drawn (sucked) in from the first port 60a to the second air chamber 74c2 via the suction path 56a of the valve body 56B and the inlet valve 64. That is, the discharging operation in the first air chamber 74c1 and the suction operation in the second air chamber 74c2 are performed at the same time. In addition, when the piston 76A moves in the direction of the arrow B due to the vibration of the vehicle 12 or a restoring force of the spring 76b which is compressed in the first air chamber 74c1, the suction operation is executed on the first air chamber 74c1 side and the discharging operation is executed on the second air chamber 74c2 side.

As described above, in the case of the pump portion 14D, the discharging operation can be performed regardless of the movement of the piston 76A in the direction of the arrow A and in the direction of the arrow B, and substantially double pumping capability is provided compared to those of the pump portions 14A to 14C. As a result, for example, in a case where compressed air is pressure-accumulated in the pressure accumulation tank 68 (see FIGS. 4 to 6), it is possible to provide substantially double pressure accumulation per unit time. That is, it is possible to perform pressure accumulation at high speed or to increase a pressure accumulation amount, and to shorten a cleaning cycle for the lens 18a. In addition, in the example described above, a case where a cleaning target is one (for example, the lens 18a) is illustrated, but in order to improve the accumulation efficiency of the pump portion 14D, the downstream side of the pressure accumulation tank 68 is branched into plurality, the compressed air can be supplied from one pressure accumulation tank 68 to the plurality of the cleaning targets, and it is possible to expand the cleaning system 10 while maintaining simplicity of the cleaning system 10.

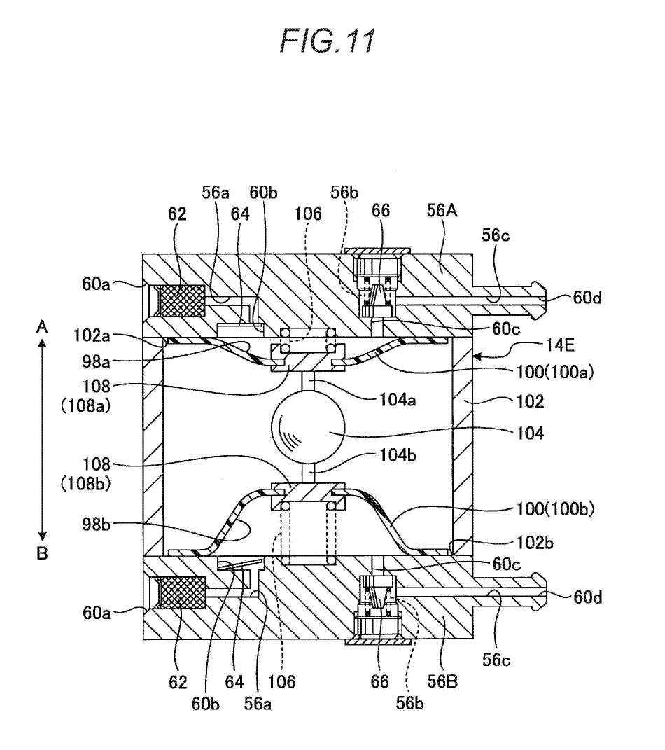

A pump portion 14E illustrated in FIG. 11 is the same of the pump portion 14D illustrated in FIG. 10 in that two valve bodies 56A and 56B are provided, but is different from the pump portion 14D illustrated in FIG. 10 in that a first air chamber 98a and a second air chamber 98b which perform drawing-in and discharging of air are partitioned (formed) by a diaphragm 100. Therefore, in the description of FIG. 11, detailed description of the valve bodies 56A and 56B will be omitted.

The pump portion 14E is configured of a case 102, a mass body 104, the diaphragm 100, the valve bodies 56A and 56B, and the like.

The case 102 is, for example, a cylindrical component and includes opening portions 102a and 102b at both ends. The opening portion 102a is covered with the valve body 56A and the opening portion 102b is covered with the valve body 56B. The valve bodies 56A and 56B are fixed to the case 102 by a fastening member such as a screw and a seal member (not illustrated) is interposed in a joining portion to maintain airtightness. As described in the pump portion 14D, the valve body 56A includes a first port 60a, a second port 60b, a third port 60c, and a fourth port 60d. The first port 60a functions as a suction port and the fourth port 60d functions as a discharging port. In addition, in the valve body 56A, the diaphragm 100 (diaphragm 100a) that covers the second port 60b and the third port 60c is fixed to a surface on which the second port 60b and the third port 60c are formed in a slackened state. A first air chamber 98a is formed by the forming surface of the second port 60b and the third port 60c of the valve body 56A, and the diaphragm 100a. Moreover, at a substantially center portion of the diaphragm 100a, a spring 106 which is disposed between the valve body 56A and the diaphragm 100a is supported on one surface side and a bracket 108 (bracket 108a) for fixing a shaft 104a supporting the mass body 104 is fixed to the other surface side.

Similarly, in the valve body 56B including the first port 60a, the second port 60b, the third port 60c, and the fourth port 60d, the diaphragm 100 (diaphragm 100b) that covers the second port 60b and the third port 60c is fixed to a surface on which the second port 60b and the third port 60c are formed in a slackened state. A second air chamber 98b is formed by the forming surface of the second port 60b and the third port 60c of the valve body 56B, and the diaphragm 100b. At a substantially center portion of the diaphragm 100b, a spring 106 which is disposed between the valve body 56B and the diaphragm 100b is supported on one surface side and a bracket 108 (bracket 108b) for fixing a shaft 104b supporting the mass body 104 is fixed to the other surface side.

The mass body 104 is a member that oscillates by an inertial force in response to the vibration of the vehicle 12 and is formed of, for example, metal, hard rubber, or the like. In the case of FIG. 11, the mass body 104 has, for example, a spherical shape, but the mass body 104 may oscillate in response to the vibration of the vehicle 12, and may have another shape. In the case of FIG. 11, a case where the mass body 104 oscillates toward the valve body 56A side so that the first air chamber 98a is in a reduced state and the second air chamber 98b is in an enlarged state is illustrated. In a case where vibration is not applied, the spring 106 of the first air chamber 98a and the spring 106 of the second air chamber 98b are balanced, the mass body 104 stops at an neutral position (for example, the center position) in the case 102, and a set pressure of the spring 106 is set, so that volumes of the first air chamber 98a and the second air chamber 98b are substantially the same as each other.

Similar to the pump portions 14A to 14D, the pump portion 14E having such a configuration is disposed at a position which is easily affected by the vibration of the vehicle 12 and executes the pumping operation due to the vibration of the vehicle 12. For example, when the mass body 104 moves in the direction of the arrow A due to the vertical vibration of the vehicle 12, the diaphragm 100a is pushed toward the valve body 56A and the first air chamber 98a moves in a reducing direction. Then, the first air chamber 98a becomes a positive pressure, the inlet valve 64 of the valve body 56A closes, and the outlet valve 66 of the valve body 56A opens at the time of exceeding the set pressure by the spring 56b. As a result, the compressed air drawn in the inside of the first air chamber 98a is discharged (injected) from the fourth port 60d via a discharge path 56c of the valve body 56A. On the other hand, when the mass body 104 moves in the direction of the arrow A, the diaphragm 100b is pulled in a direction away from the valve body 56B, and the second air chamber 98b moves in an enlarged direction on the second air chamber 98b side. The second air chamber 98b becomes a negative pressure. As a result, the inlet valve 64 of the valve body 56B opens and the outlet valve 66 of the valve body 56B closes. Therefore, air (outside air) is drawn (sucked) in from the first port 60a of the valve body 56B to the second air chamber 98b via the suction path 56a of the valve body 56B and the inlet valve 64. That is, the discharging operation in the first air chamber 98a and the suction operation in the second air chamber 98b are performed at the same time. In addition, when the mass body 104 moves in the direction of the arrow B due to the vibration of the vehicle 12 or a restoring force of the spring 106 which is compressed in the first air chamber 98a, the suction operation is executed on the first air chamber 98a side and the discharging operation is executed on the second air chamber 98b side.

As described above, in the case of the pump portion 14E, the discharging operation can be performed regardless of the movement of the mass body 104 in the direction of the arrow A and in the direction of the arrow B, and similar to the pump portion 14D, substantially double pumping capability is provided compared to those of the pump portions 14A to 14C. As a result, for example, in a case where compressed air is pressure-accumulated in the pressure accumulation tank 68 (see FIGS. 4 to 6), it is possible to provide substantially double pressure accumulation per unit time. That is, it is possible to perform pressure accumulation at high speed or to increase a pressure accumulation amount, and to shorten a cleaning cycle for the lens 18a. In addition, in the example described above, a case where a cleaning target is one (for example, the lens 18a) is illustrated, but in order to improve the accumulation efficiency of the pump portion 14E, the downstream side of the pressure accumulation tank 68 is branched into plurality, the compressed air can be supplied from one pressure accumulation tank 68 to the plurality of the cleaning targets, and it is possible to expand the cleaning system 10 while maintaining simplicity of the cleaning system 10. Moreover, in a case where the mass body 104 oscillates in the directions of the arrows A and B, the volumes of the first air chamber 98a and the second air chamber 98b are most efficiently changed, but even in a case where the mass body 104 oscillates in a direction other than in the directions of the arrows A and B, the volumes of the first air chamber 98a and the second air chamber 98b can be changed. For example, even in a case where the vehicle 12 accelerates, decelerates, or turns, the mass body 104 receives an inertial force to change the shapes of the diaphragm 100a and the diaphragm 100b. That is, the pumping operation is executed by changing the volumes of the first air chamber 98a and the second air chamber 98b. As a result, the pumping operation can be performed more efficiently compared to the pump portions 14A to 14D. In addition, it is preferable that the pump portions 14A to 14D are disposed so that the sliding directions of the pistons 76, 80, 76A are oriented in a direction most affected by the vibration of the vehicle 12, but the case of the pump portion 14E, it is possible to response to vibration in various directions. As a result, the pump portion 14E has a higher degree of freedom in selecting in the installation location and the installation posture, and equipment of the cleaning system 10 to the vehicle 12 facilitates than those of the pump portions 14A to 14D.

In the pump portion 14D and the pump portion 14E, the air discharged from the fourth port 60d of the valve body 56A and the air discharged from the fourth port 60d of the valve body 56B may be injected by using one nozzle 16, or may be injected from the nozzles 16 which are different from each other. For example, cleaning of the lens 18a of the imaging portion 18 and the sensor surface of the distance measuring sensor may be performed by one cleaning system 10. In addition, in the example of FIG. 1, an example in which the cleaning system 10 is applied to the lens 18a of the imaging portion 18 is illustrated. In another embodiment, for example, the cleaning system 10 may be applied to an imaging portion disposed in the front portion 12b of the vehicle or the side mirror 12c, and the same effects can be obtained. In addition to the imaging portion 18 or the distance measuring sensor, the cleaning target may be the information collecting surface of the information acquiring portion for collecting information of the periphery of the vehicle 12 and, for example, may be an illuminance sensor, a rain sensor, or the like. In addition, it is possible to regard the reflecting surface of the side mirror 12c that acquired a reflected image as information as the information collecting surface, the reflecting surface may be cleaned, and the same effects as those of the embodiments described above can be obtained.

In addition, in FIG. 1, an example in which the pump portion 14 is disposed in the suspension apparatus 38 of a right rear wheel is illustrated, but may be disposed in the suspension apparatus 38 of another wheel 50. In addition, the pump portion 14 may be disposed in each of a plurality of the suspension apparatuses 38, or a plurality of the pump portions 14 may be disposed in one suspension apparatus 38. In addition, in a case where the plurality of the pump portions 14 are disposed, air discharged from each of the pump portions 14 may be injected from one nozzle 16, or may be injected from the nozzle 16 which is provided in each pump portion 14. In addition, the air discharged from each pump portion 14 is pressure-accumulated in one pressure accumulation tank 68 and may be injected, or may be injected from the pressure accumulation tank 68 provided in each pump portion 14. Moreover, it is preferable that the pump portion 14 is disposed in the suspension apparatus 38 of the wheel 50 near the cleaning target. In this case, a distance from the pump portion 14 to the nozzle 16 is shortened, a pressure loss is reduced, and cleaning can be efficiently executed.

A cleaning system according to an aspect of this disclosure includes a pump portion that includes an air chamber that is capable of drawing in air from an outside, and an oscillating body which oscillates due to vibration of a vehicle and changes a volume of the air chamber so as to discharge the air drawn in the air chamber from the air chamber; and a nozzle that is disposed to face an information collecting surface of an information acquiring portion provided in the vehicle and injects the air discharged from the air chamber onto the information collecting surface. In this configuration, for example, the pump portion moves the oscillating body due to vibration of the vehicle to discharge the air. That is, air injection is enable without using a motor or the like. As a result, it is possible to blow air onto the information collecting surface of the information acquiring portion to perform removal of adhered dirt and suppression of adhesion of dirt without consuming electric energy.

For example, the cleaning system according to the aspect of this disclosure may further include a pressure accumulation tank that is provided between the pump portion and the nozzle to store the air discharged from the pump portion; and a valve body that is provided between the pressure accumulation tank and the nozzle to limit a flow of the air from the pressure accumulation tank. In this configuration, for example, it is possible to accumulate the air discharged from the pump portion by the vibration of the vehicle in the pressure accumulation tank in a high pressure state. In addition, it is possible to open the pressure-accumulated air by a valve opening operation in the high pressure state and to inject the air, thereby obtaining stronger cleaning power.

In the cleaning system according to the aspect of this disclosure, for example, the valve body may be a solenoid valve. In this configuration, for example, it is possible to execute cleaning using the high pressure air at a timing desired by a user. In addition, in a case where a valve body capable of adjusting a valve opening degree is used as the solenoid valve, it is possible to adjust an injection pressure and to increase a cleaning variation.

In the cleaning system according to the aspect of this disclosure, the pressure accumulation tank may be capable of containing a cleaning liquid and supplying a cleaning liquid mixture gas to the nozzle. In this configuration, for example, it is possible to inject the cleaning liquid together with the high pressure air at high pressure and to improve a cleaning ability. In addition, since the cleaning liquid is in a mist state, it is possible to apply a small amount of the cleaning liquid over a wide range and to suppress excessive application.

In the cleaning system according to the aspect of this disclosure, for example, the pump portion may be connected to a part of a suspension apparatus of the vehicle and may oscillate the oscillating body according to a movement of the suspension apparatus. In this configuration, for example, the pump portion is disposed at one of most vibratable portions in the vehicle, so that it is possible to efficiently perform pumping and to efficiently execute discharging of air.

In the cleaning system according to the aspect of this disclosure, for example, the pump portion may include the oscillating body and a housing that forms the air chamber and accommodates the oscillating body to be oscillated, one of the oscillating body and the housing may be rotatably connected to a part of a vehicle body of the vehicle, and the other thereof may be rotatably connected to a part of an arm portion of the suspension apparatus which connects the vehicle body and a wheel. In this configuration, for example, the oscillating body is oscillated directly and forcedly with respect to the housing by an up-and-down operation of the arm portion due to an up-and-down movement (vibration) of the wheel, so that a volume change of the air chamber can be repeatedly executed. As a result, drawing-in and discharging of air of the pump portion can be performed more efficiently.

In the cleaning system according to the aspect of this disclosure, the pump portion may include two air chambers with the oscillating body interposed therebetween, and may discharge the air from each of the air chambers by a reciprocating movement of the oscillating body. In this configuration, for example, discharging efficiency of air is improved and it is possible to perform stronger cleaning for a longer period.

In the cleaning system according to the aspect of this disclosure, for example, the pump portion may include an air chamber defined by a diaphragm and the oscillating body may change a volume of the air chamber by deforming the diaphragm to discharge the air. In this configuration, for example, the oscillating body can react to acceleration, deceleration, and turning of the vehicle, and vibration in any direction of a rightward direction, a leftward direction, an upward direction, and a downward direction such as vibration due to a shape of a road surface, and it is possible to more efficiently execute discharging (pumping) of air.

Although embodiments and the modification examples of this disclosure are described, these embodiments and modification examples are presented by way of examples and are not intended to limit the scope of this disclosure. These novel embodiments can be implemented in various other forms and various omissions, substitutions, and changes can be made without departing from the spirit of this disclosure. These embodiments and modifications thereof are included in the scope and gist of this disclosure and are included in this disclosure described in the claims and the equivalent scope thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A cleaning system comprising:
a pump portion that includes an air chamber that is capable of drawing in air from an outside, and an oscillating body which oscillates due to vibration of a vehicle and changes a volume of the air chamber so as to discharge the air drawn in the air chamber from the air chamber; and
a nozzle that is disposed to face an information collecting surface of an information acquiring portion provided in the vehicle and injects the air discharged from the air chamber onto the information collecting surface.

2. The cleaning system according to claim 1, further comprising:
a pressure accumulation tank that is provided between the pump portion and the nozzle to store the air discharged from the pump portion; and
a valve body that is provided between the pressure accumulation tank and the nozzle to limit a flow of the air from the pressure accumulation tank.

3. The cleaning system according to claim 2,
wherein the valve body is a solenoid valve.

4. The cleaning system according to claim 2,
wherein the pressure accumulation tank is capable of containing a cleaning liquid and supplying a cleaning liquid mixture gas to the nozzle.

5. The cleaning system according to claim 3,
wherein the pressure accumulation tank is capable of containing a cleaning liquid and supplying a cleaning liquid mixture gas to the nozzle.

6. The cleaning system according to claim 1,
wherein the pump portion is connected to a part of a suspension apparatus of the vehicle and oscillates the oscillating body according to a movement of the suspension apparatus.

7. The cleaning system according to claim 2,
wherein the pump portion is connected to a part of a suspension apparatus of the vehicle and oscillates the oscillating body according to a movement of the suspension apparatus.

8. The cleaning system according to claim 3,
wherein the pump portion is connected to a part of a suspension apparatus of the vehicle and oscillates the oscillating body according to a movement of the suspension apparatus.

9. The cleaning system according to claim 4,
wherein the pump portion is connected to a part of a suspension apparatus of the vehicle and oscillates the oscillating body according to a movement of the suspension apparatus.

10. The cleaning system according to claim 5,
wherein the pump portion is connected to a part of a suspension apparatus of the vehicle and oscillates the oscillating body according to a movement of the suspension apparatus.

11. The cleaning system according to claim 6,
wherein the pump portion includes the oscillating body and a housing that forms the air chamber and accommodates the oscillating body to be oscillated,
one of the oscillating body and the housing is rotatably connected to a part of a vehicle body of the vehicle, and the other thereof is rotatably connected to a part of an arm portion of the suspension apparatus which connects the vehicle body and a wheel.

12. The cleaning system according to claim 1,
wherein the pump portion includes two air chambers with the oscillating body interposed therebetween, and discharges the air from each of the air chambers by a reciprocating movement of the oscillating body.

13. The cleaning system according to claim 2,
wherein the pump portion includes two air chambers with the oscillating body interposed therebetween, and discharges the air from each of the air chambers by a reciprocating movement of the oscillating body.

14. The cleaning system according to claim 3,
wherein the pump portion includes two air chambers with the oscillating body interposed therebetween, and discharges the air from each of the air chambers by a reciprocating movement of the oscillating body.

15. The cleaning system according to claim 4,
wherein the pump portion includes two air chambers with the oscillating body interposed therebetween, and discharges the air from each of the air chambers by a reciprocating movement of the oscillating body.

16. The cleaning system according to claim 5,
wherein the pump portion includes two air chambers with the oscillating body interposed therebetween, and discharges the air from each of the air chambers by a reciprocating movement of the oscillating body.

17. The cleaning system according to claim 6,
wherein the pump portion includes two air chambers with the oscillating body interposed therebetween, and discharges the air from each of the air chambers by a reciprocating movement of the oscillating body.

18. The cleaning system according to claim 1,
wherein the pump portion includes an air chamber defined by a diaphragm and the oscillating body changes a volume of the air chamber by deforming the diaphragm to discharge the air.
